(19) United States
(12) Patent Application Publication
(10) Pub. No.: US 2025/0044032 A1
(43) Pub. Date: Feb. 6, 2025

(54) A REFRACTORY ANCHOR FOR LINING AN OBJECT, SUCH AS A THERMAL VESSEL

(71) Applicant: SILICON HOLDING B.V., 's-Gravenhage (NL)

(72) Inventors: Jerome Michael GAROT, Wateringen (NL); Danielle Francesca GAROT, Wateringen (NL)

(21) Appl. No.: 18/718,305

(22) PCT Filed: Dec. 9, 2022
(86) PCT No.: PCT/NL2022/050711

§ 371 Date: Jun. 10, 2024

(30) Foreign Application Priority Data
Dec. 20, 2021 (NL) 2030192

(51) Int. Cl. F27D 1/14

(52) U.S. Cl. CPC F27D 1/141

(57) ABSTRACT

A refractory anchor for lining an object, such as a thermal vessel, including a mounting element positioned in the center of the refractory anchor that is adapted for mounting the refractory anchor to the object. An anchoring system comprising a plurality of refractory anchors. A method of installing such an anchoring system.

The invention relates to a refractory anchor for lining an object, such as a thermal vessel, comprising a mounting element positioned in the center of the refractory anchor that is adapted for mounting the refractory anchor to the object.

The invention further relates to an anchoring system comprising a plurality of refractory anchors.

The invention also relates to a method of installing such an anchoring system.

WO2020/216714 discloses refractory anchors for lining an object, such as a thermal vessel. The known refractory anchor comprises a mounting element positioned in the center of the refractory anchor that is adapted for mounting the refractory anchor to the object. These refractory anchors can also be used in an anchoring system. This anchoring system can be installed by a method using at least two refractory anchors to produce at least one hexagonal cell. The design of the known refractory anchors is such that when using three refractory anchors it is possible to produce two hexagonal cells.

It is an object of the invention to provide an improved refractory anchor. In particular, it is an object to provide a refractory anchor bringing design freedom for cells and/or designed for producing a relatively high number of cells with a relatively low number of refractory anchors. In another aspect, it is an object to provide a refractory anchor configured for increased and/or improved dispersion of the liner material during application and subsequent curing of the liner material.

At least one of these objects is achieved with a refractory anchor as claimed in claim 1.

The refractory anchor comprises:
(a) a mounting element positioned in the center of the refractory anchor that is adapted for mounting the refractory anchor to the object;
(b) at least three three-anchor fin arrangements that are each directly connected to the mounting element by a first anchor fin positioned in each three-anchor fin arrangement.

This configuration of the refractory anchor with at least three three-anchor fin arrangements provides a new improved basic design of the refractory anchor which provides excellent and long lasting results for anchoring lining material for protecting equipment against a high temperature and/or abrasive environment as a result of processes occurring inside vessels, conduits, cyclones and other installations. By means of this refractory anchor with the at least three three-anchor fin arrangements, a relatively large number of cell shapes can be formed, i.e. the improved refractory anchor brings (more) design freedom for cell shapes. A partial cell shape may for example be formed by a combination of the first anchor fin and another anchor fin in one of the at least three three-anchor fin arrangements and by the first anchor fin and another anchor fin in one other of the three-anchor fin arrangements. For example, three half-hexagonal shapes with a single refractory anchor can be formed. Further, the refractory anchor with the at least three three-anchor fin arrangements makes it possible to produce three cells by using three refractory anchors, including cells with a hexagonal shape. Hence, the refractor anchor enables to provide a relatively large number of cells, for example hexagonal shaped cells, on an object such as a thermal vessel by using relatively less refractory anchors. In this way, the number of refractory anchors to be installed on a certain surface area of the object such as a thermal vessel and the associated installation time for installing refractory anchors, can be reduced drastically, whereas at the same time the configuration of the refractory anchor is such that at least similar results, if not improved results, can be obtained for anchoring lining material for protecting equipment against a high temperature and/or abrasive environment, when compared with conventional anchors.

In one aspect, each three-anchor fin arrangement includes a center portion connected to the first anchor fin, a second anchor fin, and a third anchor fin, wherein the first anchor fin, the second anchor fin, and the third anchor fin of each three-anchor fin arrangement radially extend away from the center portion in its respective three-anchor fin arrangement.

In a further aspect, outermost peripheral edges of the mounting element and outermost peripheral edges of the at least three three-anchor fin arrangements define an upper surface and lower surface of the refractory anchor as well as outermost side surfaces of the second anchor fin and the third anchor fin in each three-anchor fin arrangement, wherein the outermost peripheral edges of the mounting element and/or the outermost peripheral edges of the three-anchor fin arrangements define external grooves and/or external voids in one of: the upper surface of the refractory anchor, the lower surface of the refractory anchor, and/or the outermost side surfaces of the second anchor fin and/or the third anchor fin in each three-anchor fin arrangement. The external grooves and/or external voids defined by the outermost peripheral edges of the mounting element and/or the outermost peripheral edges of the three three-anchor fin arrangements are configured to facilitate flow and dispersion of liner material during application of the liner material. In other words, the external grooves and/or external voids of the refractory anchor improve flow and facilitate more homogenous dispersion. In this manner, the likelihood of premature liner cracking by loads can be reduced while the thermal vessel is in use.

In certain aspects, external grooves and/or external voids are present in the upper surface of the refractory anchor such that portions of the upper surface of the refractory anchor are present in different planes and are configured to facilitate flow and dispersion of liner material during application of the liner material. Improved abrasion resistance of the liner can be achieved because portions of the upper surface of the refractory anchor reside in different planes (i.e., certain portions of the refractory anchor's upper surface are recessed relative to other portions of the upper surface). When the liner material is applied and subsequently cured, the overall exposed uppermost surface area of the upper surface of the disclosed anchor can be greatly reduced when compared to conventional refractory anchors. By reducing the overall exposed uppermost surface area of the upper surface of the anchors disclosed herein, the total uppermost surface of the anchor exposed to an abrasive environment while the thermal vessel is in use is greatly reduced, which advantageously leads to reduced corrosion of the refractory anchor, reduced disassociation of the refractory anchor from the liner associated with refractory anchor corrosion, and increased liner lifespan as well as increased use of the thermal vessel. External grooves and/or external voids may be present in the lower surface of the refractory anchor such that portions of the lower surface of the refractory anchor are present in different planes and are configured to facilitate flow and dispersion of liner material during application of the liner material. Further, the external grooves and/or external voids may be present in the outermost side surfaces of the second anchor fin and/or the third anchor fin in each three-anchor fin arrangement such that portions of outermost side surfaces of the second anchor fin and/or the third anchor fin in each three-anchor fin arrangement of the refractory anchor are present in different planes and are configured to facilitate flow and dispersion of liner material during application of the liner material.

In another aspect, the at least three three-anchor fin arrangements are positioned such that the first anchor fins of the three-anchor fin arrangements are connected to the mounting element at an equal angle relative to one another. For example, the equal angle is 120 degrees between two first anchor fins of two separate three-anchor fin arrangements of one refractory anchor for providing cells with a hexagonal shape by means of the refractory anchors.

In a further aspect, the maximum dimensions of the first anchor fin, the second anchor fin, and the third anchor fin of each three-anchor fin arrangement are identical or at least substantially identical. The dimensions of each anchor fine are defined by its width, length and height, wherein the width of each anchor fin is the smallest dimension compared to the length dimension and height dimension. The length dimension of each anchor fin extends radially away from the center portion, wherein the height dimension extends parallel to a virtual center line of the center portion. With such identical maximum dimensions of the first anchor fin, the second anchor fin, and the third anchor fin, relatively heavy loads can be evenly absorbed by the refractory anchor mounted in its center to the object, such that a refractory anchor with a relatively long life span can be obtained.

It is also an object to provide an improved anchoring system comprising a plurality of refractory anchors. This object is achieved with the claim directed to an anchoring system. In such an anchoring system the refractory anchors are arranged in a tessellated pattern. The tessellated pattern may a honeycomb pattern, wherein the refractory anchors are arranged in an ordered array of substantially hexagonal cells, in which:
(i) each hexagonal cell is part of a row and a column of the tessellated pattern,
(ii) each row comprises a set of co-linear, adjacent hexagonal cells; and
(iii) each column comprises a set of co-linear, spaced-apart hexagonal cells, or vice versa. Such a pattern provides an increased liner lifespan, in particular an increased thermal vessel liner lifespan.

In one aspect, adjacent rows of the tessellated pattern at least partially overlap one another, and/or adjacent columns of the tessellated pattern at least partially overlap one another. In another aspect, the hexagonal cells are two-opening cells formed by an arrangement of two refractory anchors proximate one another. These two-opening cells may be obtained by:
(i) a first of the two refractory anchors forming two sides of a hexagonal cell,
(ii) a second of the two refractory anchors forming four sides of the hexagonal cell, and
(iii) two openings are defined between the first refractory anchor and second refractory anchor.

It is also an object to provide a method of installing the anchoring system on an object such as a thermal vessel. This object is achieved with the claim directed to a method. The method comprises at least the following steps:
(a) arranging a plurality of refractory anchors as discussed in this disclosure in a tessellated pattern on the object; and
(b) mounting the mounting elements of the refractory anchors to the object.

The method may also comprise the step of pouring refractory liner material into the tessellated pattern on the object.

The present invention will be explained in more detail below with reference to the appended figures showing an exemplary embodiment of a refractory anchor and an exemplary embodiment of an anchoring system.

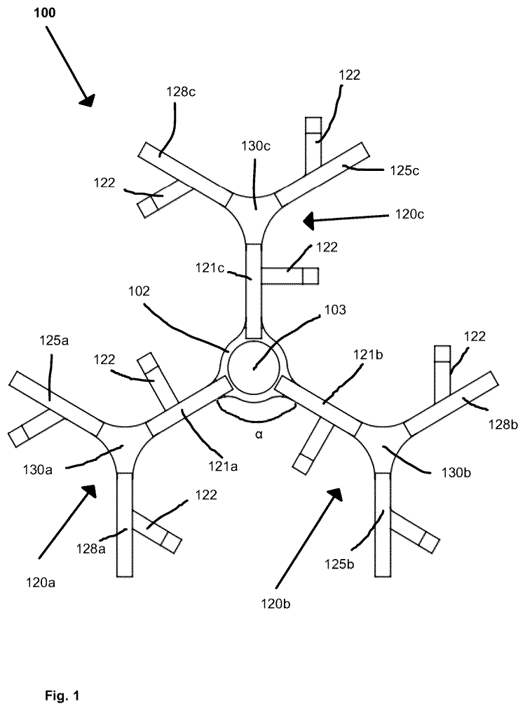

FIG. 1 shows a top view of a refractory anchor;

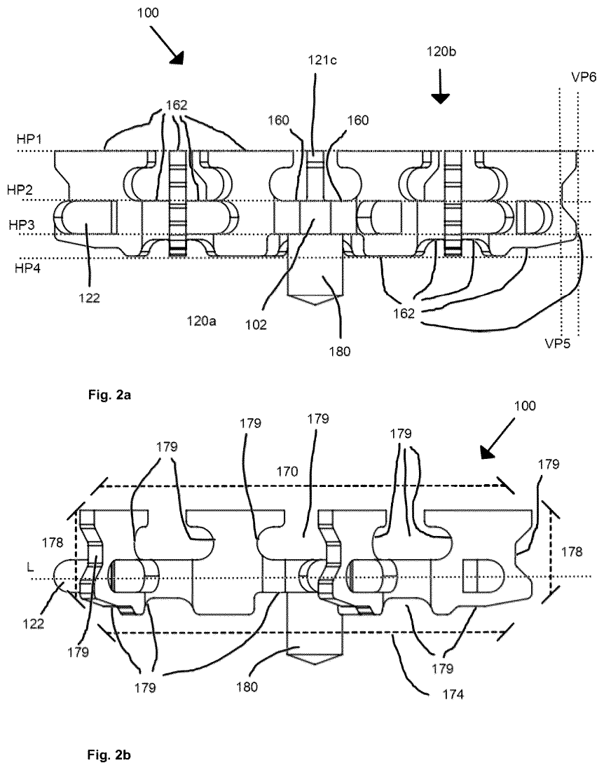

FIGS. 2a,b show side views of the refractory anchor shown in FIG. 1;

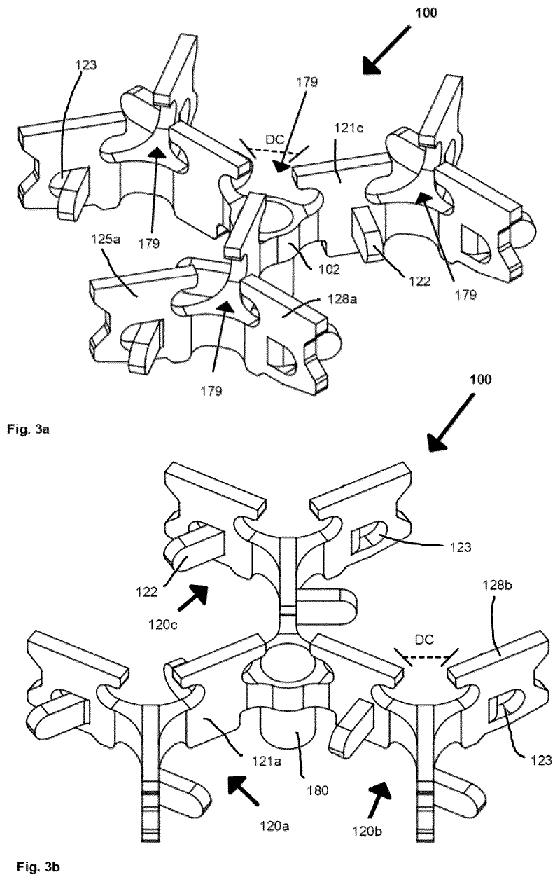

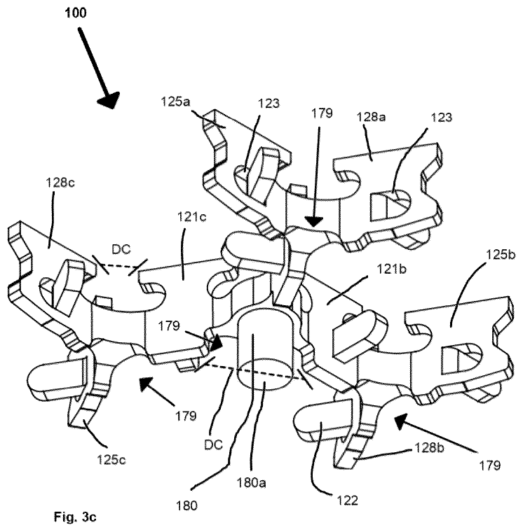

FIGS. 3a-c show various perspective views of the refractory anchor shown in FIGS. 1 and 2a,b,

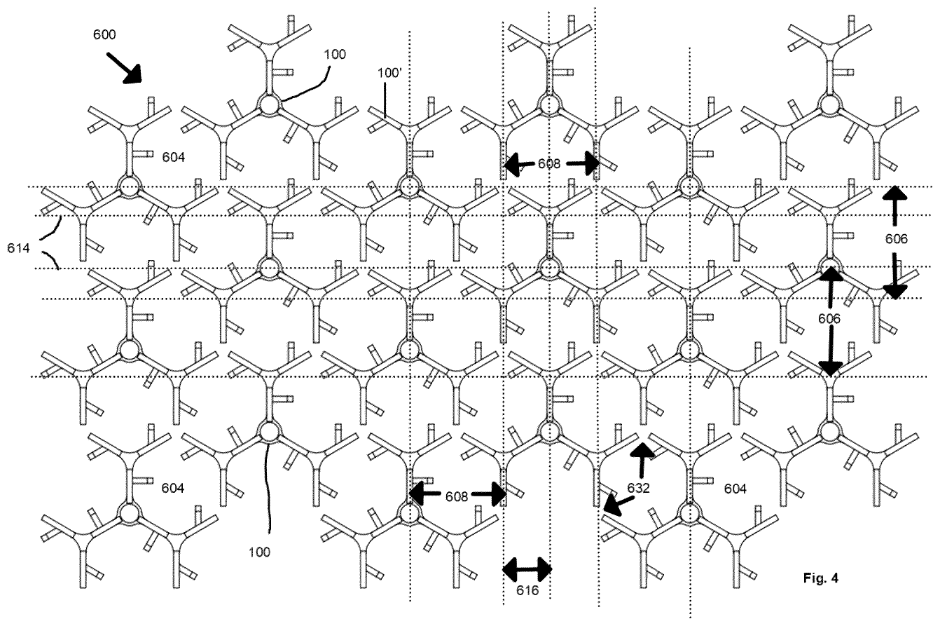

FIG. 4 shows a top view of an anchoring system provided with a plurality of identical refractory anchors, wherein in the anchoring system the refractory anchor shown in FIGS. 1, 2a,b and 3a-c has been used.

Like parts are indicated by the same reference signs in the various figures. Each feature disclosed with reference to the figure can also be combined with another feature disclosed in this disclosure including the claims, unless it is evident for a person skilled in the art that these features are incompatible.

A refractory anchor 100 is shown in FIGS. 1-3c for lining an object (not shown), such as a thermal vessel. The refractory anchor 100 is configured for increased and/or improved dispersion of the liner material during application and subsequent curing of the liner material.

The refractory anchor 100 comprises:
(a) a mounting element 102 positioned in the center 103 of the refractory anchor 100 that is adapted for mounting the refractory anchor 100 to the object;
(b) at least three three-anchor fin arrangements 120a, 120b, 120c. The three three-anchor fin arrangements 120a, 120b, 120c are each directly connected to the mounting element 102 by a first anchor fin 121a, 121b, 121c positioned in each three-anchor fin arrangement 120a, 120b, 120c. Each three-anchor fin arrangement 120a, 120b, 120c includes a center portion 130a, 130b, 130c connected to the first anchor fin 121a, 121b, 121c, a second anchor fin 125a, 125b, 125c, and a third anchor fin 128a, 128b, 128c. The first anchor fin 121a, 121b, 121c, the second anchor fin 125a, 125b, 125c, and the third anchor fin 128a, 128b, 128c of each three-anchor fin arrangement 120a, 120b, 120c radially extend away from the center portion 130a, 130b, 130c in its respective three-anchor fin arrangement 120a, 120b, 120c. The first anchor fin 121a, 121b, 121c in each three-anchor fin arrangement 120a, 120b, 120c is positioned between and directly connected to the mounting element 102 and the center portion 130a, 130b, 130c of the respective three-anchor fin arrangement 120a, 120b, 120c.

In the refractory anchor 100 a virtual center line (extending through center 103) of the mounting element 102 coincides with a virtual center line of the refractory anchor 100. The distance between a virtual center line (extending through center 103) of the mounting element 102 and the three center portions 130a, 130b, 130c of the respective three-anchor fin arrangement 120a, 120b, 120c is identical or substantially identical, i.e. this distance also determines the length of the first anchor fin 121a, 121b, 121c. The length of the first anchor fins 121a, 121b, 121c is equal to the length of the second anchor fins 125a, 125b, 125c, and/or the length of the third anchor fins 128a, 128b, 128c.

Outermost peripheral edges 160 (FIG. 2b) of the mounting element 102 and outermost peripheral edges 162 of the at least three three-anchor fin arrangements 120a, 120b, 120c define an upper surface 170 (FIG. 2b), a lower surface 174 of the refractory anchor 100 as well as outermost side surfaces 178 of the second anchor fin 125a, 125b, 125c and the third anchor fin 128a, 128b, 128c in each three-anchor fin arrangement 120a, 120b, 120c, wherein the outermost peripheral edges 160 of the mounting element 102 and/or the outermost peripheral edges 162 of the three-anchor fin arrangements 120a, 120b, 120c define external grooves and/or external voids (collectively) 179: the upper surface 170 of the refractory anchor, and/or the lower surface 174 of the refractory anchor, and/or the outermost side surfaces 178 of the second anchor fin 125a, 125b, 125c and/or the third anchor fin 128a, 128b, 128c in each three-anchor fin arrangement. The different planes disclosed herein are described in an orientation relative to the longitudinal axis L (FIG. 2b) of the refractory anchor 100. “HP” refers to horizontal planes, which are substantially parallel to the longitudinal axis L of the refractory anchor 100, and “VP” refers to vertical planes, which are substantially transverse or perpendicular to the longitudinal axis L of the refractory anchor 100. The external grooves and/or external voids 179 are present in the upper surface 170 of the refractory anchor such that portions of the upper surface of the refractory anchor are present in different planes HP1, HP2 and are configured to facilitate flow and dispersion of liner material during application of the liner material. Alternatively stated and as further shown in FIGS. 3a,b, the uppermost surface of each fin in the upper surface 170 of the refractory anchor 100 is discontinuous DC relative to one another due to the external grooves and/or external voids 179 formed by each respective center portion 130a, 130b, 130c of each three-anchor fin arrangement relative to the uppermost surface of each fin as well as the external grooves and/or external voids 179 formed by the mounting element relative to the uppermost surface of each fin. Hence, the refractory anchor 100 has four external voids 179 in its upper surface 170, one void 179 in each three-anchor fin arrangement 120a, 120b, 120c and one void above the mounting element 102, i.e. a central void 179. Improved abrasion resistance of the thermal vessel liner is achieved due to the unique structural features of the refractory anchor's upper surface. In particular, the improved abrasion resistance is achieved because portions of the upper surface 170 of the refractory anchor reside in different planes HP1 and HP2 respectively. When the liner material is applied and subsequently cured, the overall exposed uppermost surface area of the upper surface of the disclosed anchor is greatly reduced when compared to conventional refractory anchors because the entire upper surface of the disclosed refractory anchor does not reside in the same or substantially the same plane. By reducing the overall exposed uppermost surface area of the upper surface of the anchors disclosed herein, the total uppermost surface of the anchor exposed to an abrasive environment while the thermal vessel is in use is greatly reduced, which advantageously leads to reduced corrosion of the refractory anchor 100, reduced disassociation of the refractory anchor from the liner associated with refractory anchor corrosion, and an increase in liner lifespan as well as increased use of the thermal vessel. Likewise, the lower surface 174 of the anchor 100 has a unique configuration that further aids in liner material dispersion. As shown external grooves and/or external voids 179 are present in the lower surface 174 of the refractory anchor such that portions of the lower surface of the refractory anchor are present in different planes HP3, HP4 and are configured to facilitate flow and dispersion of liner material during application of the liner material. The anchor 100 has external voids 179 in its lower surface 174, i.e. one void 179 is present below the mounting element 102 and each three-anchor fin arrangement 120a, 120b, 120c provides more than one void 179, i.e. a void 179 below the central portions 130a, 130b, 130c. Further, at least one void 179 is provided by the lower surface of the second anchor fin 125a, 125b, 125c and/or the third anchor fin 128a, 128b, 128c. Alternatively stated and as further shown in the bottom perspective view of FIG. 3c, the lowermost surface of each fin in the lower surface 174 of the refractory anchor 100 is discontinuous DC relative to one another due to the external grooves and/or external voids 179 formed in each respective center portion of each three-anchor fin arrangement relative to the lowermost surface of each fin as well as the external grooves and/or external voids 179 formed by the mounting element 102 relative to the lowermost surface of each fin. The anchor 100 has more than four external grooves and/or external voids 179 in its lower surface 174. In addition, the external grooves and/or external voids 179 are present in the outermost side surfaces 178 of the second anchor fin 125a, 125b, 125c and/or the third anchor fin 128a, 128b, 128c in each three-anchor fin arrangement such that portions of outermost side surfaces of the second anchor fin and/or the third anchor fin in each three-anchor fin arrangement of the refractory anchor are present in different planes VP5, VP6 and are configured to facilitate flow and dispersion of liner material during application of the liner material. The mentioned external grooves and external voids 179 synergistically interact with one another to facilitate and improve liner material application, dispersion, and subsequent curing, which reduces the likelihood of premature cracking of the thermal vessel liner.

In addition and as further discussed below, the refractory anchor 100 includes at least one reinforcement segment 122 connected to and extending away from one of the anchor fins of the three-anchor fin arrangements. The reinforcement segment 122 may also function to strengthen the thermal liner when the anchors 100 are in use. The refractory anchor may comprise one to nine reinforcement segments 122. In the refractory anchor 100 the nine reinforcement segments 122 are positioned in the refractory anchor in between the upper 170 and lower 174 surfaces. Each reinforcement segment 122 is directly connected to and extends away from an anchor fin of one of the three three-anchor fin arrangements 120a, 120b, 120c. In certain preferred aspects, at least the first anchor fin 121a, 121b, 121c is provided with a reinforcement segment 122 and/or each reinforcement segment 122 is positioned on a different fin of the three three-anchor fin arrangements 120a, 120b, 120c. Each reinforcement segment 122 has smaller dimensions than the anchor fins in each three fin arrangement 120a, 120b, 120c, which further aids in arranging the refractory anchors 100 in an unencumbered pattern in which each refractory anchor is spaced apart and does not contact another refractory anchor thereby maximizing the surface area that each refractory anchor convers when arranged in a desired pattern while further minimizing the number of anchors used in each pattern. In certain aspects and to better improve dispersion of the liner material by passing the liner material internally through portions of the anchor 100 to more homogeneously disperse the liner material in and around the anchor 100, internal openings 123 are formed in the anchor fins of the three-anchor fin arrangements 120a, 120b, 120c between and spaced apart from the upper surface 170, the lower surface 174 and outermost side surfaces 178 of the anchor fins and immediately adjacent to the reinforcement segment 122. The first anchor fin 121a, 121b, 121c of each three-anchor fin arrangements 120a, 120b, 120c is provided with a reinforcement segment 122, but is not provided with an internal opening immediately adjacent to the reinforcement segment 122.

As can be seen in the figures, the maximum dimensions of the first anchor fin 121a, 121b, 121c, the second anchor fin 125a, 125b, 125c, and the third anchor fin 128a, 129b, 128c of each three-anchor fin arrangement 120a, 120b, 120c are substantially identical. The length dimension of each anchor fin extends in a horizontal direction radially away from the center portion 130a, 130b, 130c, wherein the height dimension extends in a vertical direction, i.e. parallel to a virtual center line of the center portion indicated by reference sign 103 in FIG. 1.

The three three-anchor fin arrangements are positioned such that the first anchor fins of the three-anchor fin arrangements are connected to the mounting element 102 at an equal angle α (FIG. 1) relative to one another, wherein the equal angle α is 120 degrees between two first anchor fins 121a, 121b, 121c of two separate three-anchor fin arrangements of one refractory anchor to provide cells with a hexagonal shape by means of the refractory anchors 100. Although not shown, it is also possible that the refractory anchor has for example four three-anchor fin arrangements. The equal angle in such a refractory anchor is 90 degrees between two first anchor fins of two separate three-anchor fin arrangements of one refractory anchor to provide cells with different shape than a hexagonal shape.

The refractory anchor 100 further includes a mounting pin 180 connected to the mounting element 102 in which the mounting pin is configured for directly mounting the anchor onto a desired surface. The elongated mounting pin 180 is connected to the mounting element 102, wherein the elongated mounting pin 180 has a first end and a second end opposite to the first end seen in the longitudinal direction of the elongated mounting pin, wherein the first end 180a (FIG. 3c) of the elongated mounting pin 180 is adapted to be weldable to the object, and at least the second end of the elongated mounting pin is connected to the mounting element 102. The mounting pin 180 may have a circumferential recess near the second end, wherein in the recess the mounting element 102 is connected. In this way, a (vertical) movement in the direction of the virtual center line of the mounting element 102 with respect to the mounting pin 180 can be excluded or at least drastically reduced. The hole of the mounting element 102 to be connected to the mounting pin 180 may be circular. In certain aspects, the refractory anchor 100 (further including the mounting pin) may be monobloc (i.e., a unitary, cast anchor) in which no clinching mechanisms to fasten multiple parts together are necessary. However, in alternative aspects, the refractory anchor 100 and mounting pin 180 may be separate elements requiring further assembly by, for example, welding and/or equipped for another form of engagement such as a friction fit or threaded engagement, wherein the mounting pin may be made from a different material than the mounting element 102 and the three-anchor fin arrangements 120a, 12b, 120c. The mounting pin comprises either a metal or metal alloy while the remaining portions of the refractory anchor (e.g., the mounting element, the three-anchor fin arrangements, reinforcement fins/segments (when present) or any combination thereof) may comprise a non-ferrous material such as ceramics or silicon carbide. It is also possible that the remaining portions of the refractory anchor are made of a metal or metal alloy.

FIG. 4 shows a plurality of refractory anchors 100 arranged in a tessellated pattern, i.e. a honeycomb pattern, i.e. FIG. 4 shows an anchoring system 600. Such a plurality of refractory anchors 100 are mounted on an object such as a thermal vessel (not shown). In the anchoring system 600 the refractory anchors 100 are arranged in an ordered array of substantially hexagonal cells 604 in the tessellated pattern and each hexagonal cell is part of a row 606 and a column 608 of the tessellated pattern, wherein each row 606 comprises a set of co-linear, adjacent hexagonal cells 604; and each column comprises a set of co-linear, spaced-apart hexagonal cells 604, in other words the hexagonal cells 604 in a column 608 are non-adjacent to one another. In addition, adjacent rows 606 of the tessellated pattern at least partially overlap one another, and/or adjacent columns 608 of the tessellated pattern at least partially overlap one another. The overlap involves upper corners of hexagonal cells 604 in a lower row overlapping the lower corners of hexagonal cells 604 in a higher row, where the lower and higher row are adjacent. The distance of overlap is shown in FIG. 4 by dotted lines 614, wherein this distance between line 614 and a dotted line indicating row 606 indicates the overlap. Similarly, the columns 608 of the tessellated pattern 600 also overlap one another. The overlap involves side corners of the hexagonal cells 604 of adjacent columns 608 overlapping one another. The distance of overlap is shown in FIG. 4 by arrow 616. It is possible by turning FIG. 4 with 90 degrees to denote in such a “new” pattern a column 608 a row and a row 606 a column. Stated differently, the terms row and column may be used vice versa.

As can be seen in FIG. 4, in the refractory anchor 100 each semi-hexagonal shape of a hexagonal cell may be formed by a combination of the first anchor fin 121a-c and another anchor fin 125a-c; 128a-c in one of the at least three three-anchor fin arrangements and by the first anchor fin 121a-c and another anchor fin 125a-c; 128a-c in one other of the three-anchor fin arrangements 120a-c. In the pattern 600 each hexagonal cell 604 is a two-opening cell formed by an arrangement of two refractory anchors 100 proximate one another, i.e. each cell 604 comprises two openings 632. In the anchoring system 600 a first of two refractory anchors 100 forms two sides of a hexagonal cell, and a second 100′ (FIG. 4) of the two refractory anchors forms four sides of the hexagonal cell, and two openings 632 are defined between the first refractory anchor 100 and second refractory anchor 100′.

Further, the refractory anchor 100 with the three three-anchor fin arrangements makes it possible to produce three hexagonal cells by using only three refractory anchors 100. This is not possible with conventional anchors known from WO2020/216714. By the improved design of the refractory anchors, the number of refractory anchors 100 to be installed on a certain surface area of the object such as a thermal vessel and the associated installation time for installing refractory anchors 100, can be reduced drastically.

The hole of the mounting element 102 for receiving the mounting pin 180 may be at least partially non-circular (not shown). Non-circular also includes substantially circular with a serrated inner hole (opening/ring) connecting to mounting pin 102 or a hole (opening/ring) with notches. Such a non-circular inner surface of the hole facilitates to obtain an improved mechanical resistance against rotation of the mounting element 102 with respect to the mounting pin 180. The non-circular inner surface of the hole may also be applied on other refractory anchors than disclosed in this disclosure, for example a refractory anchors with only two three-anchor fin arrangements or two other anchor fin arrangements. The outer surface of the mounting pin 180 used for the connection with the mounting element 102 may be shaped in a corresponding manner to the non-circular hole of the mounting pin to further increase the mechanical resistance against rotation of the mounting element 102 with respect to the mounting pin 180. This outer surface of the mounting pin 180 can be provided by the circumferential recess discussed above. In one aspect, the non-circular hole comprises at least one flat section, for example two or more flat sections. An embodiment of a hole with at least one flat section is a D-shaped hole.

1. A refractory anchor for lining an object comprising:
(a) a mounting element positioned in the center of the refractory anchor that is adapted for mounting the refractory anchor to the object;
(b) at least three three-anchor fin arrangements that are each directly connected to the mounting element by a first anchor fin positioned in each three-anchor fin arrangement.

2. The refractory anchor according to claim 1, wherein each three-anchor fin arrangement includes a center portion connected to the first anchor fin, a second anchor fin, and a third anchor fin, wherein the first anchor fin, the second anchor fin, and the third anchor fin of each three-anchor fin arrangement radially extend away from the center portion in its respective three-anchor fin arrangement.

3. The refractory anchor of claim 2, wherein the first anchor fin in each three-anchor fin arrangement is positioned between and directly connected to the mounting element and the center portion of the respective three-anchor fin arrangement.

4. The refractory anchor of claim 2, wherein outermost peripheral edges of the mounting element and outermost peripheral edges of the at least three three-anchor fin arrangements define an upper surface and lower surface of the refractory anchor as well as outermost side surfaces of the second anchor fin and the third anchor fin in each three-anchor fin arrangement, wherein the outermost peripheral edges of the mounting element and/or the outermost peripheral edges of the three-anchor fin arrangements define external grooves and/or external voids in one of: the upper surface of the refractory anchor, the lower surface of the refractory anchor, and/or the outermost side surfaces of the second anchor fin and/or the third anchor fin in each three-anchor fin arrangement.

5. The refractory anchor of claim 4, wherein external grooves and/or external voids are present in the upper surface of the refractory anchor such that portions of the upper surface of the refractory anchor are present in different planes and are configured to facilitate flow and dispersion of liner material during application of the liner material.

6. The refractory anchor of claim 4, wherein external grooves and/or external voids are present in the lower surface of the refractory anchor such that portions of the lower surface of the refractory anchor are present in different planes and are configured to facilitate flow and dispersion of liner material during application of the liner material.

7. The refractory anchor of claim 4, wherein the external grooves and/or external voids are present in the outermost side surfaces of the second anchor fin and/or the third anchor fin in each three-anchor fin arrangement such that portions of outermost side surfaces of the second anchor fin and/or the third anchor fin in each three-anchor fin arrangement of the refractory anchor are present in different planes and are configured to facilitate flow and dispersion of liner material during application of the liner material.

8. The refractory anchor of claim 4, wherein one to nine reinforcement segments are positioned in the refractory anchor in between the upper and lower surfaces of the refractory anchor.

9. The refractory anchor of claim 8, wherein at least the first anchor fin is provided with a reinforcement segment, preferably each reinforcement segment is positioned on a different fin of each three-anchor fin arrangement.

10. The refractory anchor of claim 1, wherein the at least three three-anchor fin arrangements are positioned such that the first anchor fins of the three-anchor fin arrangements are connected to the mounting element at an equal angle relative to one another.

11. The refractory anchor of claim 1, wherein the maximum dimensions of the first anchor fin, the second anchor fin, and the third anchor fin of each three-anchor fin arrangement are substantially identical.

12. The refractory anchor of claim 1, further comprising an elongated mounting pin connected to the mounting element, wherein the elongated mounting pin has a first end and a second end opposite to the first end seen in the longitudinal direction of the elongated mounting pin, wherein the first end of the elongated mounting pin is adapted to be weldable to the object, and at least the second end of the elongated mounting pin is connected to the mounting element.

13. The refractory anchor according to claim 12, wherein the mounting pin is made from a different material than the mounting element and the three-anchor fin arrangements.

14. The refractory anchor of claim 1, wherein the refractory anchor is monobloc.

15. A plurality of refractory anchors of claim 1 arranged in a tessellated pattern.

16. An anchoring system comprising a plurality of refractory anchors of claim 1 arranged in a tessellated pattern.

17. The anchoring system of claim 16, wherein the refractory anchors are arranged in an ordered array of substantially hexagonal cells in the tessellated pattern:
(i) each hexagonal cell is part of a row and a column of the tessellated pattern,
(ii) each row comprises a set of co-linear, adjacent hexagonal cells; and
(iii) each column comprises a set of co-linear, spaced-apart hexagonal cells, or vice versa.

18. The anchoring system of claim 17, wherein adjacent rows of the tessellated pattern at least partially overlap one another, and/or adjacent columns of the tessellated pattern at least partially overlap one another.

19. The anchoring system of claim 18, wherein the hexagonal cells are two-opening cells formed by an arrangement of two refractory anchors proximate one another.

20. The anchoring system of claim 19, wherein:
(i) a first of the two refractory anchors forms two sides of a hexagonal cell,
(ii) a second of the two refractory anchors forms four sides of the hexagonal cell, and
(iii) two openings are defined between the first refractory anchor and second refractory anchor.

21. A method of installing the anchoring system of claim 16 on an object, such as a thermal vessel, comprising:
(a) arranging a plurality of refractory anchors according to claim 1 in a tessellated pattern on the object; and
(b) mounting the mounting elements of the refractory anchors to the object.

22. The method of claim 21, further comprising pouring refractory liner material into the tessellated pattern on the object.
